(19) United States
(12) Patent Application Publication
(10) Pub. No.: US 2013/0273789 A1
(43) Pub. Date: Oct. 17, 2013

(54) MALE CONTACT FOR DEVICE FOR ELECTRICALLY CONNECTING CONDUCTORS AND ELECTRICAL CONNECTOR PROVIDED WITH SAID CONTACTS

(71) Applicant: Amphenol - Air LB, Blagny (FR)

(72) Inventor: Roy Gilles, Carignan (FR)

(21) Appl. No.: 13/799,474

(22) Filed: Mar. 13, 2013

(30) Foreign Application Priority Data
Mar. 13, 2012 (FR) FR1252226

(51) Int. Cl. H01R 13/20

(52) U.S. Cl. CPC H01R 13/20
USPC 439/884

(57) ABSTRACT

This male contact for a device for electrically connecting conductors comprises a first part (2) provided with an axial internal seat (4) for inserting the conductor and mechanically fixing it in the contact and a second part (3) extending from the first part (2) and intended for electrical connection of the contact.

The second part has an axial internal recess (8).

The invention relates to the electrical connections sector and relates more particularly to the male contacts for a device for electrically connecting conductors, and in particular for electrical connectors.

An electrical connector generally comprises two paired parts each comprising one or more contacts, respectively male and female.

Each of the parts of the connector generally comprises a case inside which the corresponding contacts are held by means of an insulant.

The exposed ends of the conductors to be connected are equipped with the male and female contacts which are fixed onto them, for example by means of crimping.

In the aeronautical sector, a large number of such connectors provided with their male and female contacts are used in order to perform the electrical connection of the conductors in the network on-board the aircraft. As is known, low weight is one of the major constraints imposed by aircraft manufacturers on equipment suppliers. This constraint exists in particular in the electrical connections sector owing to the very large number of connectors which are used on-board an aircraft.

As regards the contacts, these generally have two parts which form an extension of each other, i.e. a first part comprising an axial internal seat for performing mechanical fixing and for electrically connecting a conductor to be connected and a second part for electrically connecting the contact to another paired contact.

The contacts are conventionally made of metallic material so that they have a not insignificant weight. This is the case in particular with the male contacts.

In the light of the above, the proposed object of the invention is to provide a low-weight male contact.

The invention therefore relates to a male contact for a device for electrically connecting conductors, comprising a first part provided with an axial internal seat for inserting the conductor and mechanically fixing it in the contact, and a second part extending from the first part and intended for electrical connection of the contact.

According to a general characteristic feature of this male contact, the second part has an axial internal recess.

It has been noted that the presence of this axial internal recess, while guaranteeing effective electrical connection of contact, also resulted in a weight gain of about 10% for the contacts, allowing the installation of cable with an AWG (American Wire Gauge) number of between 18 and 24, namely a cable with a cross section ranging from 1 to 0.25 mm². Of course, with higher gauges a greater weight gain may be obtained.

Moreover, owing to the presence of the axial internal recess, a reduction in weight of the contacts is obtained for the same geometric dimensions, with the result that the contacts may be adapted to conventional connectors without any variation in their thermal behaviour.

According to another characteristic feature of the invention, the axial recess extends along the entire length of the second part and emerges outside the contact at an end of the second part opposite to the first part.

In one embodiment, the axial recess and the said internal seat communicate and form an internal axial passage extending from one side to the other of the contact.

Advantageously, the first part has a radial hole ensuring communication of the internal seat with the outside of the male contact.

The contact may be made of an electrically conductive metallic material, in particular copper alloy.

The contact may also have an outer annular shoulder between the first and second parts.

Moreover, a frustoconical portion may arranged between the said shoulder and the second part.

The invention also relates, according to a second aspect, to a connector provided with at least one male contact as defined above.

Other objects, characteristic features and advantages of the invention will become clear upon reading the following description provided solely by way of a non-limiting example with reference to the accompanying drawings in which:

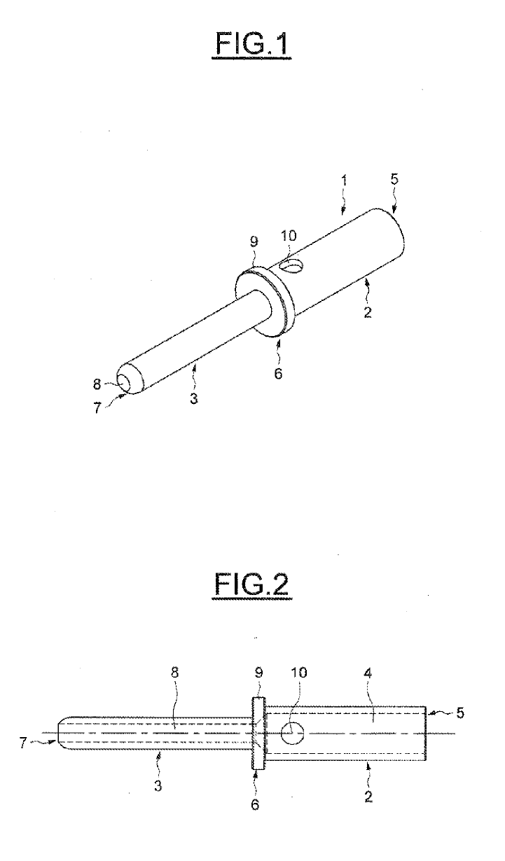

FIG. 1 is a perspective view of a male contact according to the invention;

FIG. 2 is a longitudinal view of the contact according to FIG. 1;

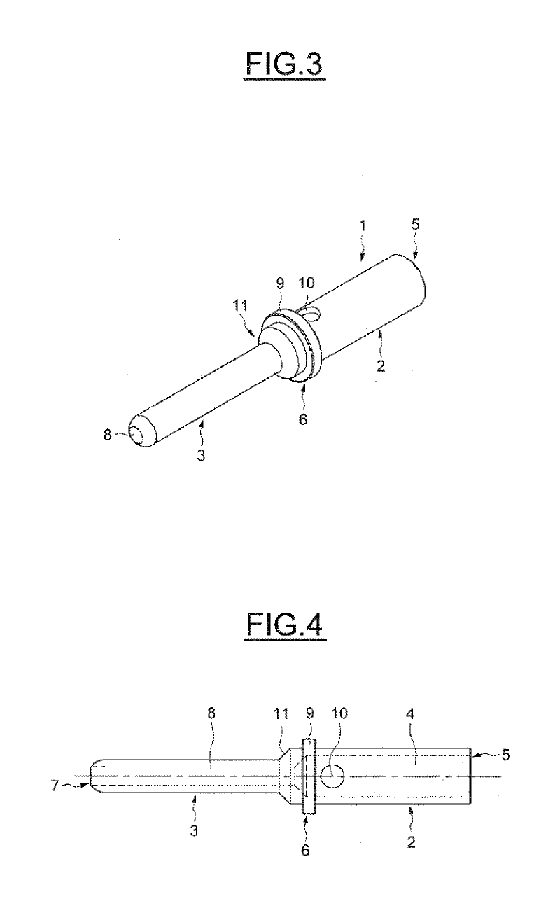

FIG. 3 shows a variant of the male contact according to the invention; and

FIG. 4 is a longitudinal view of the male contact according to FIG. 3.

With reference to FIGS. 1 and 2, a first embodiment of a male contact according to the invention, denoted by the general reference number 1, will be firstly described.

This contact 1 is made of a single piece of metallic material, for example copper alloy. It is intended to be mounted in a connector formed for example by two paired parts which are fixed together during assembly of the connector, one part comprising an assembly consisting of at least one male contact and the other part comprising an assembly corresponding to at least one female contact, these contacts cooperating during assembly of the two parts in order to ensure electrical connection of the male and female contacts, respectively.

As can be seen in FIGS. 1 and 2, the male contacts have a first part 2 for performing mechanical fixing and for electrically connecting an exposed end of a conductor to be connected (not shown) and a second part 3, extending coaxially from the first part 2 and intended to cooperate with a corresponding female contact for electrically connecting the contact 1 and the conductor to which it is fixed.

As can be seen in FIG. 2, the first part 2 has an axial internal seat 4 extending from a first end 5 of the contact towards a middle part 6. This internal seat is intended for insertion of the exposed end of the conductor to be connected. For example, for a cable with AWG number 20, the internal seat 4 has a diameter of between 1.17 and 1.22 mm, whereby the first part 2 may have an external diameter of between 1.73 and 1.78 mm. Moreover, for a male contact with AWG number 20, the length of the first part 2 may range between 5.87 and 6.02 mm.

As regards the second part 3, which forms the male part of the contact, this extends from the middle part 6 to one end 7 of the contact opposite to the first end.

In order to reduce the weight of the contact, this second part 3 has an axial internal recess 8 which extends from the middle part 6 towards the free end 7 of the contact via which the recess emerges outside the contact.

For example, the length of the second part 3 ranges between 7.49 and 7.62 mm for a contact with AWG number 20 and its outer diameter may range between 0.99 and 1.04 mm. As regards the axial internal recess 8, its diameter may range between 0.46 and 0.51 mm for this type of contact.

As can be seen, the axial internal recess 8 communicates, in the region of the middle part 6, with the axial internal seat 4 of the first part 2 in such a way as to form an internal axial passage extending along the contact between the first and second ends 5 and 7. It will be noted that, in the middle part, the contact has an annular shoulder 9 which forms a stop used during insertion of the contact inside the connector.

It will be noted, moreover, that the exposed end of a conductor is held by means of crimping inside the axial internal seat 4. A radial hole 10 is advantageously formed in the thickness of the first part 2 of the contact in order to ensure communication of the internal seat 4 with the exterior so as to allow visual inspection via this “spy hole” in order to check, before crimping, that the cable is correctly inserted inside the contact.

It will be noted that the invention is not limited to the embodiment described above. In fact, with reference to FIGS. 3 and 4, the male contact may also have any other configuration corresponding to the form of the connector in which it is mounted. In fact, as can be seen in these figures, in which elements identical to the elements described with reference to FIGS. 1 and 2 have the same reference numbers, it is also possible, by way of a variant, to arrange the annular shoulder 9 offset towards the first end 5 of the contact and to provide, between this shoulder 9 and the second part 3, a frustoconical portion 11 intended to cooperate with a corresponding portion provided in the connector and inside which the internal recess 8 of the second male part 3 extends.

Finally it will be noted that the invention described above may also be applied to all other sizes of contact, in particular to contacts with an AWG number of between 20 and 00, corresponding to cable sections of between 0.60 and 67.2 mm².

1. Male contact for a device for electrically connecting conductors, comprising a first part provided with an axial internal seat for inserting the conductor and mechanically fixing it in the contact and a second part extending from the first part and intended for electrical connection of the contact, wherein the second part has an axial internal recess.

2. Male contact according to claim 1, wherein the axial recess extends along the entire length of the second part and emerges outside the contact via an end of the second part opposite to the first part.

3. Male contact according to claim 1, wherein the axial recess and the said internal seat communicate and form an internal axial passage extending from one side to the other of the contact.

4. Male contact according to claim 1, wherein the first part has a radial hole ensuring communication of the internal seat with the outside of the male contact.

5. Male contact according to claim 1, wherein the male contact is made of electrically conductive metallic material.

6. Male contact according to claim 1, further comprising an external annular shoulder between the first and second parts.

7. Male contact according to claim 6, further comprising a frustoconical portion arranged between the said shoulder and the second part.

8. Connector comprising at least one male contact according to claim 1.

9. Male contact according to claim 1, wherein the male contact is made of a copper alloy.
